(19) United States
(12) Patent Application Publication
(10) Pub. No.: US 2026/0292799 A1
(43) Pub. Date: Sep. 24, 2026

(54) FREQUENCY DOMAIN CORRELATION INFORMATION SIGNALING FOR TRANSMISSION LAYERS OF A PRECODED CHANNEL

(71) Applicant: QUALCOMM Incorporated, San Diego, CA (US)

(72) Inventors: Chih-Hao LIU, San Diego, CA (US); Jing SUN, San Diego, CA (US); Yu ZHANG, San Diego, CA (US); Jing LEI, San Diego, CA (US)

(21) Appl. No.: 19/088,041

(22) Filed: Mar. 24, 2025

(51) Int. Cl. H04W 72/0453; H04B 7/0456; H04L 25/49

(52) U.S. Cl. CPC H04W 72/0453; H04B 7/0456; H04L 25/4927

(57) ABSTRACT

Systems and techniques are provided for wireless communications. For example, a network entity can determine respective frequency domain (FD) correlation information for each precoding resource block group (PRG) of a plurality of PRGs associated with a precoded channel. The network entity can determine average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs. The network entity can transmit signaling indicative of the average FD correlation information for each transmission layer.

### INTRODUCTION

Aspects of the present disclosure generally relate to wireless communication. In some implementations, examples are described for indicating frequency domain correlation information associated with a precoded channel.

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. In some aspects, the network entity can be a network entity configured for transmission of one or more signals using a wireless network, and may, for example, be implemented as one or more of a base station, a UE, etc. The network entity includes at least a processing system, where the processing system is configured to: determine respective frequency domain (FD) correlation information for each precoding resource block group (PRG) of a plurality of PRGs associated with a precoded channel; determine average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and transmit signaling indicative of the average FD correlation information for each transmission layer.

In another example, a method for wireless communication is provided, the method including: determining respective frequency domain (FD) correlation information for each precoding resource block group (PRG) of a plurality of PRGs associated with a precoded channel; determining average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and transmitting signaling indicative of the average FD correlation information for each transmission layer.

In another example, a non-transitory computer-readable storage medium is provided comprising instructions stored thereon which, when executed by at least one processor, causes the at least one processor to: determine respective frequency domain (FD) correlation information for each precoding resource block group (PRG) of a plurality of PRGs associated with a precoded channel; determine average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and transmit signaling indicative of the average FD correlation information for each transmission layer.

In another example, an apparatus is provided for wireless communication. The apparatus includes: means for determining respective frequency domain (FD) correlation information for each precoding resource block group (PRG) of a plurality of PRGs associated with a precoded channel; means for determining average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and means for transmitting signaling indicative of the average FD correlation information for each transmission layer.

In another illustrative example, a network entity for wireless communication is provided. In some aspects, the network entity can be a network entity configured for reception of one or more signals using a wireless network, and may, for example, be implemented as one or more of a base station, a UE, etc. The network entity includes at least a processing system, where the processing system is configured to: receive frequency domain (FD) correlation information corresponding to a precoded channel, wherein the FD correlation information is indicative of an average FD correlation for each transmission layer of a plurality of transmission layers associated with the precoded channel; determine a channel estimation matrix for one or more transmission layers of the plurality of transmission layers, wherein the channel estimation matrix corresponds to the precoded channel and is determined based on the average FD correlation for each transmission layer of the one or more transmission layers; and determine channel estimation information for the precoded channel using the channel estimation matrix.

In another example, a method for wireless communication is provided, the method including: receiving frequency domain (FD) correlation information corresponding to a precoded channel, wherein the FD correlation information is indicative of an average FD correlation for each transmission layer of a plurality of transmission layers associated with the precoded channel; determining a channel estimation matrix for one or more transmission layers of the plurality of transmission layers, wherein the channel estimation matrix corresponds to the precoded channel and is determined based on the average FD correlation for each transmission layer of the one or more transmission layers; and determining channel estimation information for the precoded channel using the channel estimation matrix.

In another example, a non-transitory computer-readable storage medium is provided comprising instructions stored thereon which, when executed by at least one processor, causes the at least one processor to: receive frequency domain (FD) correlation information corresponding to a precoded channel, wherein the FD correlation information is indicative of an average FD correlation for each transmission layer of a plurality of transmission layers associated with the precoded channel; determine a channel estimation matrix for one or more transmission layers of the plurality of transmission layers, wherein the channel estimation matrix corresponds to the precoded channel and is determined based on the average FD correlation for each transmission layer of the one or more transmission layers; and determine channel estimation information for the precoded channel using the channel estimation matrix.

In another example, an apparatus is provided for wireless communication. The apparatus includes: means for receiving frequency domain (FD) correlation information corresponding to a precoded channel, wherein the FD correlation information is indicative of an average FD correlation for each transmission layer of a plurality of transmission layers associated with the precoded channel; means for determining a channel estimation matrix for one or more transmission layers of the plurality of transmission layers, wherein the channel estimation matrix corresponds to the precoded channel and is determined based on the average FD correlation for each transmission layer of the one or more transmission layers; and means for determining channel estimation information for the precoded channel using the channel estimation matrix.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices).

Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating a grid of time-frequency resources including a plurality of demodulation reference signal (DMRS) tones that can be used to perform frequency domain minimum mean square error (MMSE) estimation, in accordance with some examples;

FIG. 7 is a flow diagram illustrating an example of a process for wireless communication, in accordance with some examples;

FIG. 8 is a flow diagram illustrating another example of a process for wireless communication, in accordance with some examples; and

FIG. 9 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In some wireless communications systems, base stations may transmit synchronization signals and reference signals over a carrier to assist UEs with cell acquisition as well as frequency and time tracking of the carrier. For example, synchronization signals may allow UEs to detect a cell transmitted over a carrier. Synchronization signals may also allow the UEs to detect the center frequency of the carrier and achieve synchronization at the transmission time interval or symbol level. In some cases, for robust reception and demodulation across a system bandwidth, the UEs may also maintain tracking loops using reference signals that span a larger portion of the system bandwidth. Some base stations may continuously transmit reference signals such as cell reference signals (CRS) within a subset of resources of each resource block across the system bandwidth. Continuous transmission of reference signals may increase UE power consumption and in some cases may be an inefficient use of network resources, for example when no UEs are connected to or tracking timing for a cell associated with the base station. UE power consumption may also increase with the relative amount of time during which the UE is receiving reference signal transmissions.

In some examples, wireless communication networks may use one or more reference signals to maintain time and frequency synchronization between various devices communicating on the network. For example, in 4G LTE, base stations may transmit a cell-specific reference signal in each slot and resource block, where UEs within range of the 4G LTE base station configured to perform time tracking and/or frequency tracking using a received cell-specific reference signal to maintain time and frequency synchronization with the base station. In some examples, 5G NR wireless communication networks do not similarly transmit a cell-specific reference signal in every slot and resource block. In 5G NR, a base station may transmit a tracking reference signal (TRS) that a UE may use for time tracking and/or frequency tracking to maintain time and frequency synchronization with the base station.

A TRS can be a reference signal that may be used for time tracking, frequency tracking, or both. A base station may transmit at least one TRS in a cell provided by the base station, and one or more UEs may receive and use the TRS to perform synchronization and/or tracking to communicate with the base station and/or over the provided cell of the network. In some examples, a 5G NR TRS is configured as a downlink reference signal for providing time and frequency tracking at one or more UEs. UEs may, in some examples, use the TRS to perform phase noise compensation in higher-frequency bands (e.g., mmWave, etc.), to perform time synchronization for alignment with the transmission timing of a base station (e.g., gNB, etc.), associated with the TRS, to perform frequency synchronization corresponding to compensation for a carrier frequency offset, channel estimation for relatively high Doppler scenarios, etc. TRS transmission may be performed periodically and/or aperiodically in the downlink. TRS transmissions can be performed independently from various physical downlink shared channel (PDSCH) transmission, and can be used for tracking across multiple slots. As noted above, a 5G NR system may use TRS for time-frequency tracking for synchronization. In some cases, a 5G NR system may use TRS for power delay profile (PDP) tracking associated with or corresponding to channel estimation.

For example, in 5G NR, power delay profile (PDP) estimation can be performed based on synchronization signal blocks (SSBs) and/or TRS. PDP estimation can correspond to estimating time-domain characteristics of a multipath wireless channel, based on measurements of received power over different delay taps. In some examples, the transmission (and corresponding reception) of a TRS at a configured interval can be used by a UE to measure the time delays of different multipath components. For example, based on correlating received TRS signals with the respective expected sequence information for the received TRS signals, the UE can determine the time-of-arrival for each multipath component, and can form an estimate of the PDP from the multi-path component time of arrival information. In some cases, a UE can use periodic and/or aperiodic TRS receptions over time to estimate the PDP, based on using the TRS receptions to determine a channel response that can be used to determine the channel delay spread and/or coherence time for the PDP estimation.

In some cases, the PDP can be estimated from TRS and used to perform channel estimation. For example, the PDP can be estimated from TRS and used to perform minimum mean square error (MMSE) channel estimation. The PDP estimation can correspond to time-domain information, based on the PDP being determined corresponding to time-domain characteristics of the multipath wireless channel. The frequency domain transformation of the PDP can be a frequency domain (FD) correlation, for example determined as a Fourier transform of the PDP. In some examples, the PDP and/or frequency domain correlation can be estimated from TRS and used to perform channel estimation (e.g., including MMSE channel estimation, etc.).

The PDP and/or FD correlation estimated from TRS can be based on a TRS transmitted (e.g., broadcast, signaled, etc.) by a network entity (e.g., base station, gNB, etc.). In some examples, TRS signals are configured to be shared by a plurality of UEs within the wireless network, and the TRS is transmitted on a wide beam. For example, the TRS may be transmitted on a relatively wide bandwidth including a plurality of OFDM symbols and subcarriers.

When data precoding is applied on physical downlink shared channel (PDSCH) transmission, the beam associated with the PDSCH transmission on the precoded channel can be a relatively narrow beam. The beam used for PDSCH transmission on the precoded channel can be narrower (e.g., smaller in bandwidth, etc.) than the wide beam associated with the TRS. In examples where a PDP and/or FD correlation is estimated from a relatively wide band TRS, the channel estimation determined using the PDP and/or FD correlation may be inaccurate when the channel estimation is performed for a relatively narrow band channel having a bandwidth narrower than that of the relatively wide band TRS. For example, channel estimation information determined for a relatively narrow band DMRS or PDSCH transmission on a precoded channel may be inaccurate when using a PDP or FD correlation estimated from a relatively wide band TRS, based on the DMRS or PDSCH of the precoded channel being much narrower than the TRS. Precoded channels can also be associated with multiple different transmission layers, for example where each transmission layer corresponds to a path between a different combination of a transmit antenna or antenna port of the transmitting device, and a receive antenna or antenna port of the receiving device. The different transmission layers of a precoded channel can correspond to different FD correlations and/or PDPs, based on different multipath channel characteristics over the different transmission layers of the precoded channel.

There is a need for systems and techniques that can be used for signaling of frequency domain correlation information corresponding to multiple transmission layers of a precoded channel. There is a further need for systems and techniques that can be used to provide signaling and/or an indication of respective FD correlation information for each transmission layer of the multiple transmission layers of a precoded channel. In some examples, there may be a further need for reducing the overhead and/or transmission size corresponding to signaling and/or indicating the respective FD correlation information for each transmission layer of multiple transmission layers of a precoded channel.

Systems, apparatuses, processes (also referred to as methods), and computer-readable media (collectively referred to as “systems and techniques”) are described herein that can be used to provide frequency domain (FD) correlation information signaling for transmission layers of a precoded channel. For example, the systems and techniques can be used to provide an indication of respective FD correlation information for each transmission layer of the multiple transmission layers of a precoded channel. In some examples, the respective FD correlation information for each transmission layer can be signaled using a quantized indication, determined based on quantizing the respective FD correlation information associated with each transmission layer of the multiple transmission layers of the precoded channels.

For example, a transmitting device (e.g., a UE, network entity (e.g., base station, eNB, gNB, etc.)) can be configured to determine respective FD correlation information for the plurality of transmission layers of a precoded channel. In some cases, the transmitting device can determine the respective FD correlation information for each precoding resource block group (PRG) of a plurality of PRGs associated with the precoded channel. Each transmission layer of the precoded channel can correspond to one or more PRGs of the plurality of PRGs. The respective FD correlation information can be determined on a per-PRG basis and/or can be determined on a per-transmission layer basis, among various others. The systems and techniques can be used to determine average FD correlation information for each transmission layer of the plurality of transmission layers of the precoded channel, based on the respective FD correlation information for the corresponding subset of PRGs of the plurality of PRGs that is associated with each respective transmission layer. For example, the average FD correlation information for a transmission layer can be the average of the respective FD correlation determined for each PRG of the subset of PRGs associated with the transmission layer.

The average FD correlation information for each transmission layer of the plurality of transmission layers of the precoded channel can be transmitted via signaling indicative of the average FD correlation information for each transmission layer. In some cases, the signaling indicative of the average FD correlation information for each transmission layer can be transmitted to a receiving device (e.g., UE, network entity, etc.), which can be configured to use the average FD correlation information for each transmission layer to perform channel estimation corresponding to one or more transmission layers of the precoded channel. For example, the receiving device can perform or determine a minimum mean square error (MMSE) estimate corresponding to the precoded channel and/or one or more transmission layers of the precoded channel. For example, based on receiving signaling indicative of the per-layer FD correlation and/or PDP, the receiver can adjust one or more per-layer MMSE channel estimation matrices based on the indicated per-layer FD correlation and/or PDP estimation included in the received signaling (e.g., the FD indication for the multi-layer precoded channel). In some cases, the receiver can be configured to adjust the MMSE channel estimation matrix per transmission layer of the precoded channel, based on the indicated FD correlation or PDP delay spread for each transmission layer of the precoded channel.

In some cases, the signaling for the FD correlation information of the precoded channel can include a respective matrix of values corresponding to the average FD correlation information for each transmission layer. In some examples, the average FD correlation information for each transmission layer can be quantized according to a quantization configuration, and the signaling can indicate and/or include a respective quantized value determined from the average FD correlation information for each transmission layer. For example, the quantized value for a particular transmission layer (e.g., of the plurality of transmission layers) can be determined based on a comparison between the average FD correlation information for the particular transmission layer, and each candidate FD correlation of a plurality of candidate FD correlations associated with a quantization configuration. The quantization configuration and/or information indicative of the plurality of candidate FD correlations can be included in the signaling indicative of the average FD correlation information for each transmission layer.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, a processing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, processing system, or the like may include disclosure of the UE, base station, apparatus, device, computing system, processing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first processing system, a first one or more components, a first processing entity, or the like configured to receive the information; and the second network node may refer to a second UE, a second base station, a second apparatus, a second device, a second computing system, a second processing system, a second one or more components, a second processing entity, or the like.

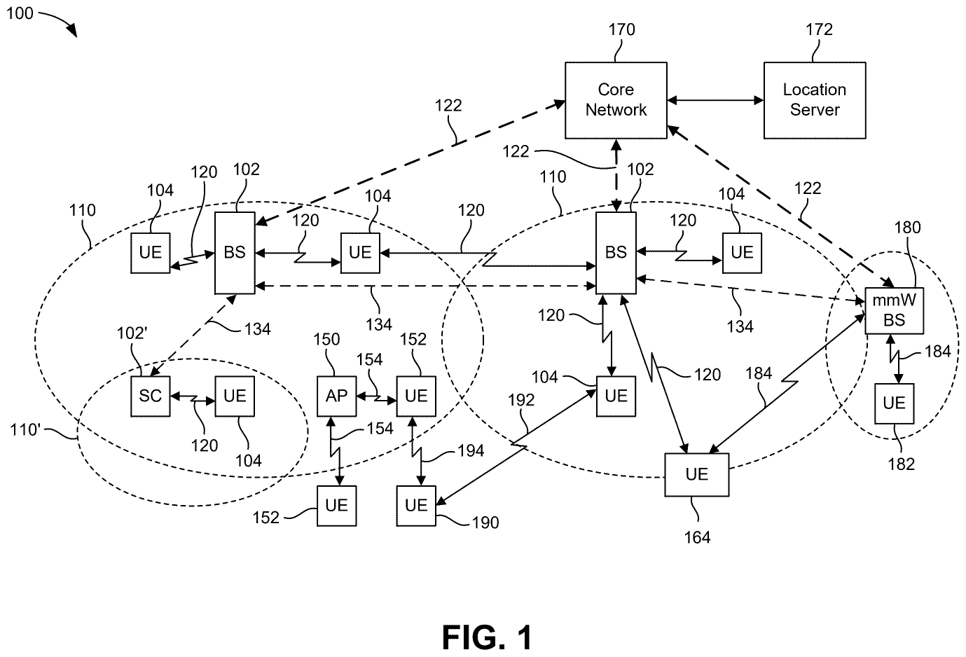

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, a processing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 100 of FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, processing system or the like may include disclosure of the UE, base station, network node, apparatus, device, computing system, processing system or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first processing system, a first set of one or more one or more components, a first processing entity, or the like configured to receive the information; and the second network entity may refer to a second UE, a second base station, a second apparatus, a second device, a second computing system, a second processing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

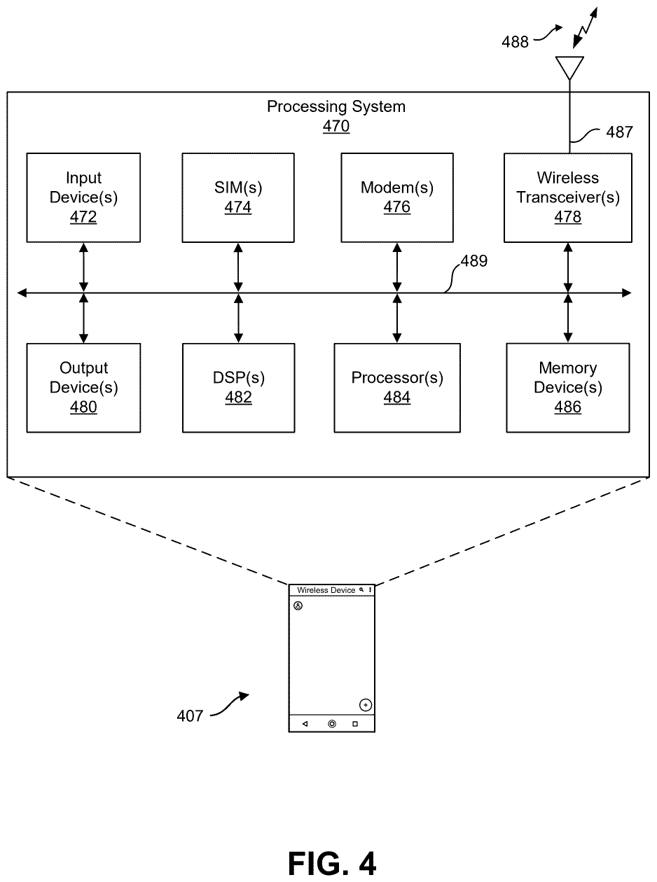

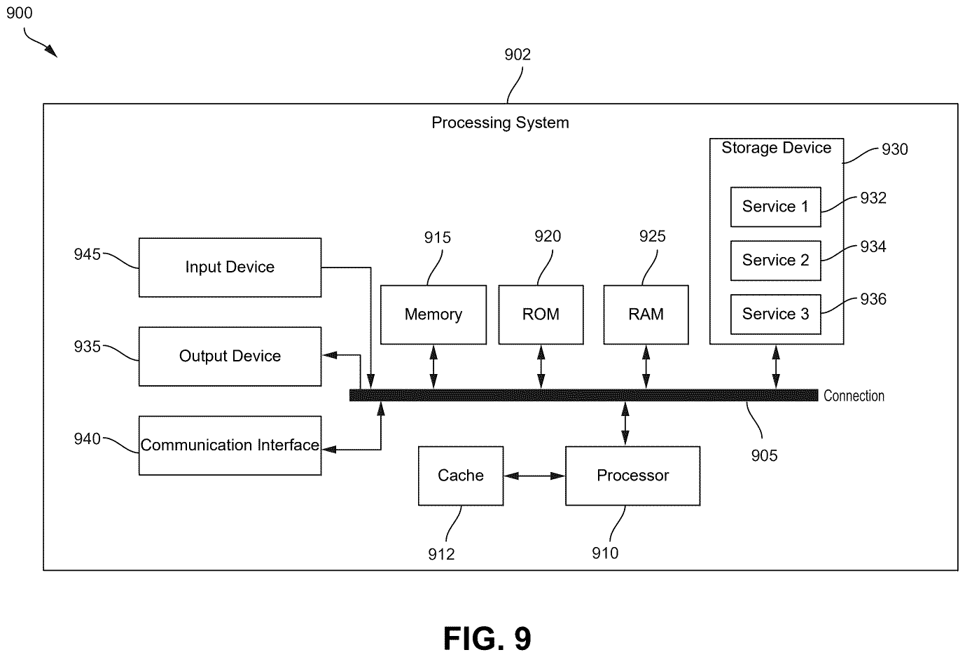

In some examples, the network entity 102 may include a processing system (e.g., such as the processing system 470 of FIG. 4 and/or the processing system 902 of FIG. 9, etc.). Similarly, the network entity 180 (e.g., a millimeter wave (mmW) base station, etc.) may include a respective processing system (e.g., such as the processing system 470 of FIG. 4 and/or the processing system 902 of FIG. 9, etc.). A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

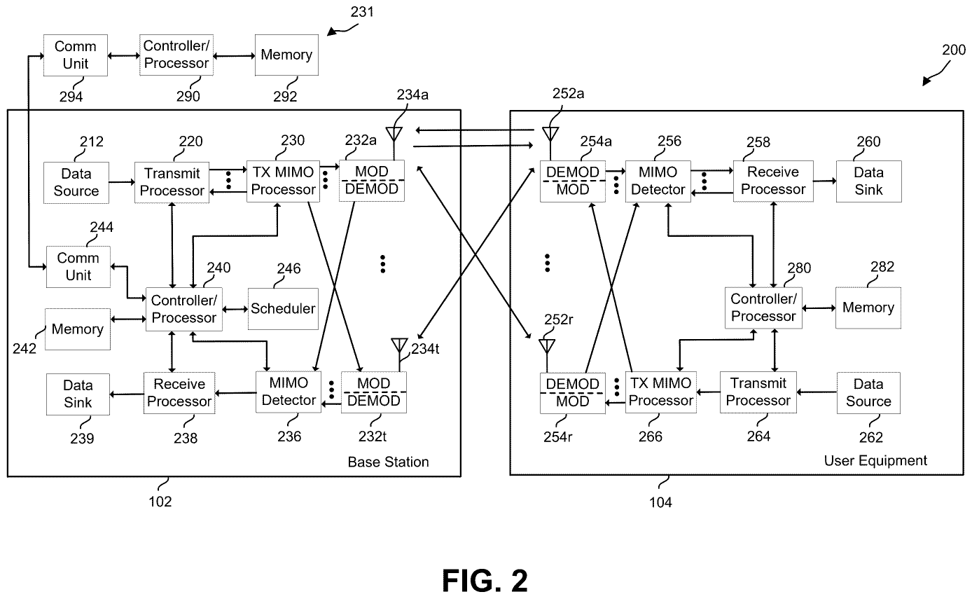

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

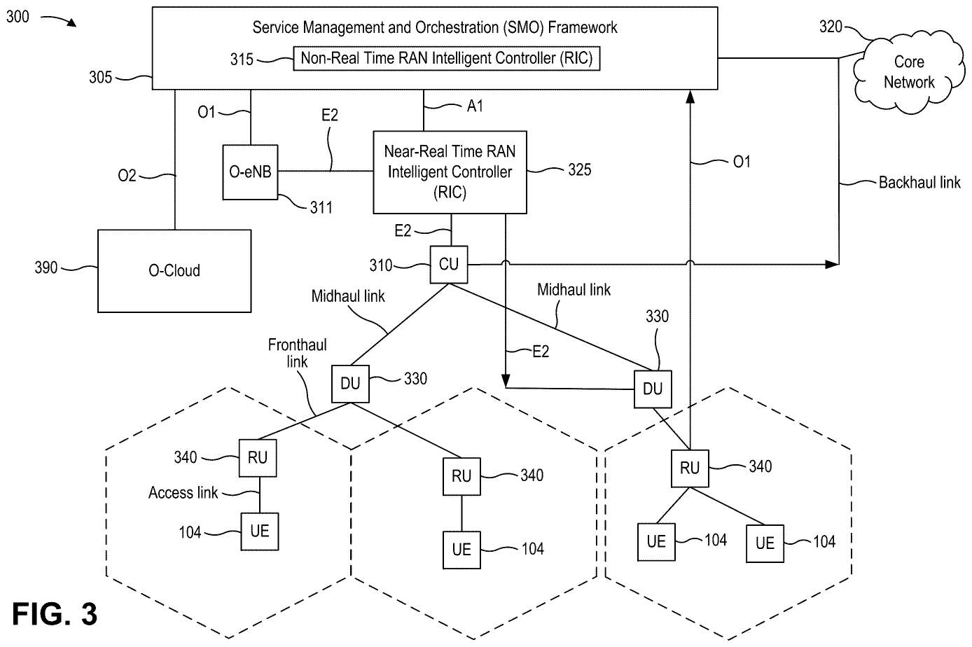

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

FIG. 4 illustrates an example of a processing system 470 of a wireless device 407. In some examples, the processing system 470 may also be referred to as a computing system. The processing system 470 may include and/or implement one or more components that are the same as or similar to respective components included in and/or implemented by the processing system 902 of FIG. 9 (e.g., and the processing system 902 of FIG. 9 may include and/or implement one or more components that are the same as or similar to respective components included in and/or implemented by the processing system 470 of FIG. 4). In some cases, the wireless device 407 may also be referred to as a user computing device. The wireless device 407 may include a client device such as a UE (e.g., UE 104, UE 152, UE 190) or other type of device (e.g., a station (STA) configured to communication using a Wi-Fi interface) that may be used by an end-user. In some cases, the processing system 470 of the wireless device 407 can be implemented by one or more of the UEs 104 of FIG. 1. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network.

The processing system 470 includes software and hardware components that may be electrically or communicatively coupled via a bus 489 (e.g., or may otherwise be in communication, as appropriate). The processing system 470 may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, the processing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The processing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, processing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the processing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the processing system 470 may include a coding-decoding device (or CODEC) configured to encode and/or decode data transmitted and/or received using the one or more wireless transceivers 478. In some cases, the processing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The processing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The processing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

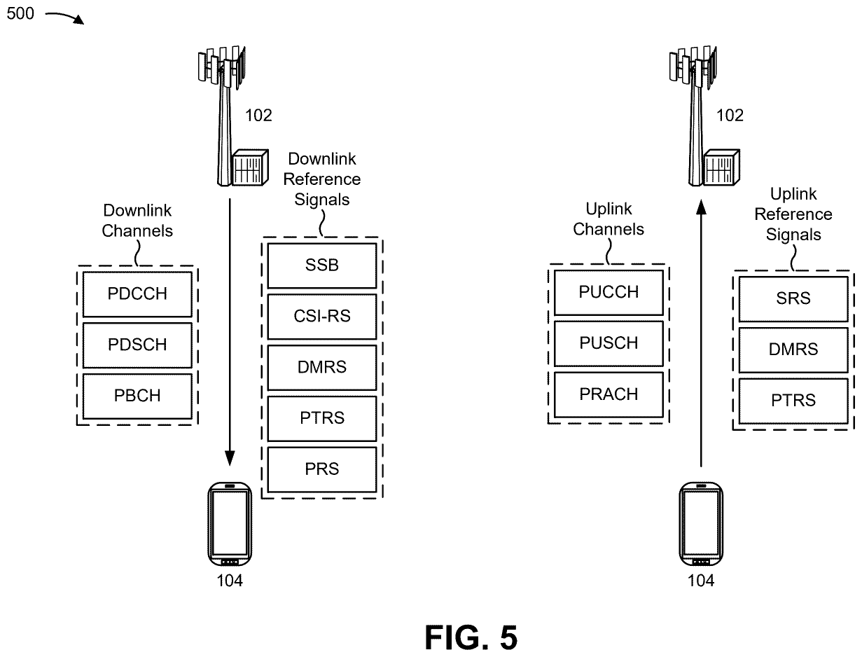

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

TRS is another example of a downlink reference signal, and may carry information from the base station 102 to the UE 104 of FIG. 5. As noted above, TRS can be used for time tracking, frequency tracking, or both. For example, a UE can use one or TRS transmissions from a base station for tracking frequency and timing offsets. In some cases, UEs may be configured to use the TRS to perform phase noise compensation in higher-frequency bands (e.g., mmWave, etc.), to perform time synchronization for alignment with the transmission timing of a base station (e.g., gNB, etc.), associated with the TRS, to perform frequency synchronization corresponding to compensation for a carrier frequency offset, channel estimation for relatively high Doppler scenarios, etc. TRS transmission may be performed periodically and/or aperiodically in the downlink. TRS transmissions can be performed independently from various physical downlink shared channel (PDSCH) transmission, and can be used for tracking across multiple slots. In some examples, a 5G NR system can use TRS for time-frequency tracking for synchronization. In some cases, a 5G NR system may use TRS for power delay profile (PDP) tracking associated with or corresponding to channel estimation.

For example, in 5G NR, power delay profile (PDP) estimation can be performed based on synchronization signal blocks (SSBs) and/or TRS. The PDP estimation can be used for estimating time-domain characteristics of a multipath wireless channel, for example based on measurements of received power over different delay taps. In some aspects, the transmission (and corresponding reception) of a TRS at a configured interval can be used by a UE to measure the time delays of different multipath components. For example, based on correlating received TRS signals with the respective expected sequence information for the received TRS signals, the UE can determine the time-of-arrival for each multipath component, and can form an estimate of the PDP from the multi-path component time of arrival information. In some cases, a UE can use periodic and/or aperiodic TRS receptions over time to estimate the PDP, based on using the TRS receptions to determine a channel response that can be used to determine the channel delay spread and/or coherence time for the PDP estimation.

In some cases, a TRS reception (e.g., a received TRS signal at a receiver, etc.) can be used for channel estimation. For example, the channel estimation can correspond to a frequency domain minimum mean square error (MMSE) estimator included and/or implemented by the device receiving the TRS signal. The PDP and/or FD correlation estimated from TRS can be based on a TRS transmitted (e.g., broadcast, signaled, etc.) by a network entity (e.g., base station, gNB, etc.). In some examples, TRS signals are configured to be shared by a plurality of UEs within the wireless network, and the TRS is transmitted on a wide beam. For example, the TRS may be transmitted on a relatively wide bandwidth including a plurality of OFDM symbols and subcarriers.

As noted above, when data precoding is applied on PDSCH, the beam used for PDSCH transmission on the precoded channel can be relatively narrow, and may be narrower than the relatively wide beam used for TRS. PDP and/or FD correlation information that is estimated from a relatively wide band TRS may correspond to an inaccurate channel estimation when using the PDP and/or FD correlation from the wide band TRS. For example, channel estimation information determined for a relatively narrow band DMRS or PDSCH transmission on a precoded channel may be inaccurate when using a PDP or FD correlation estimated from a relatively wide band TRS, based on the DMRS or PDSCH of the precoded channel being much narrower than the TRS. The systems and techniques described herein can be used to provide signaling indicative of FD correlation information corresponding to respective transmission layers of a plurality of transmission layers of a precoded channel, and/or corresponding to respective precoding resource block groups (PRGs) of a plurality of PRGs of the precoded channel.

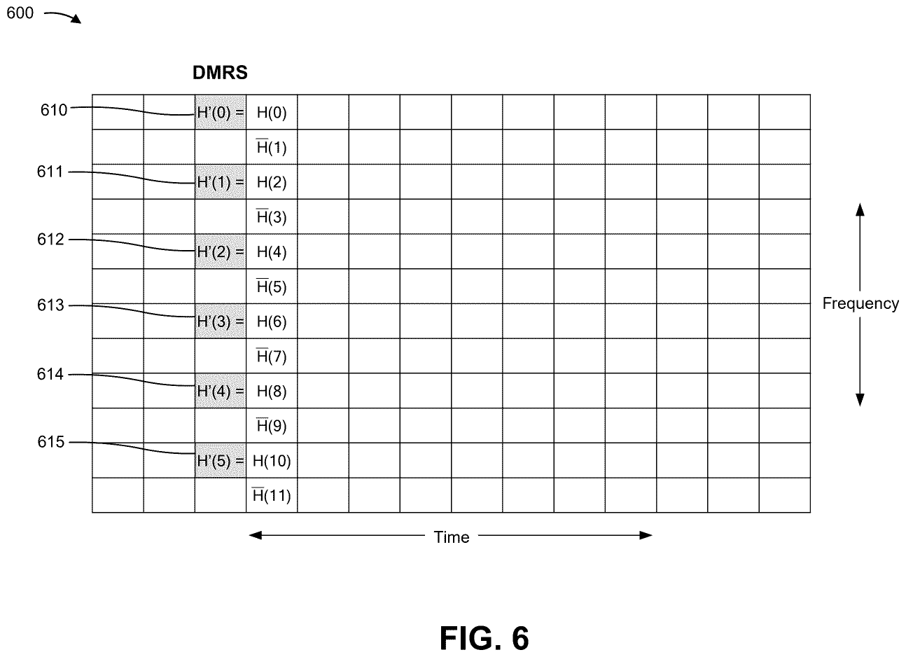

FIG. 6 is a diagram illustrating a grid of a plurality of time-frequency resources 600 (also referred to as a time-frequency resource grid or a resource grid) including a plurality of demodulation reference signal (DMRS) tones that can be used to perform frequency domain minimum mean square error (MMSE) estimation, in accordance with some examples. In some examples, the grid of time-frequency resources 600 represents time along the horizontal axis (e.g., each column of the time-frequency resource grid 600 corresponding to a different time slot of a plurality of time slots represented within the grid 600), and represents frequency along the vertical axis (e.g., each row of the time-frequency resource grid 600 corresponding to a different subcarrier of a plurality of subcarriers represented within the grid 600).

In some aspects, a frequency domain MMSE estimator can be used by a receiving device (e.g., a device receiving PUSCH, PDSCH, PDCCH, etc.) to interpolate frequency domain channel response information from a set of DMRS tones. For example, DMRS pilot tones can be used by the frequency domain MMSE estimator to interpolate the frequency domain channel response from the DMRS tones. A plurality of DMRS pilot tones are transmitted at a configured interval of frequency separation, for example corresponding to a particular subset of subcarriers of the plurality of subcarriers within a resource block. For example, the time-frequency resource grid 600 can correspond to a resource block, and a plurality of DMRS pilot tones can be transmitted within the same time slot (e.g., same column of the resource grid/resource block 600) on a configured subset of subcarriers.

In one illustrative example, a first DMRS pilot tone 610 (e.g., H′(0)) can be transmitted on a first subcarrier of the resource grid 600. A second DMRS pilot tone 611 (e.g., H′(1)) can be transmitted on a third subcarrier of the resource grid 600. A third DMRS pilot tone 612 (e.g., H′(2)) can be transmitted on a fifth subcarrier of the resource grid 600. A fourth DMRS pilot tone 613 (e.g., H′(3)) can be transmitted on a seventh subcarrier of the resource grid 600. A fifth DMRS pilot tone 614 (e.g., H′(4)) can be transmitted on a ninth subcarrier of the resource grid 600. A sixth DMRS pilot tone 615 (e.g., H′(5)) can be transmitted on an eleventh subcarrier of the resource grid 600.

The plurality of DMRS pilot tones 610-615 can be used to estimate the channel response at known locations in the frequency domain. For example, each DMRS pilot tone 610-615 is transmitted on a different subcarrier, where each subcarrier corresponds to a different, known location (e.g., frequency range) within the frequency domain. For each DMRS pilot tone of the plurality of DMRS pilot tones 610-615, a corresponding channel response estimation can be determined for the corresponding data tone(s) at the same location in the frequency domain (e.g., the corresponding data tones on the same subcarrier as one of the DMRS pilot tones).

For example, the first DMRS pilot tone 610 (e.g., H′(0)) is transmitted on the first subcarrier of the resource grid 600, and can be used to estimate the channel response information H(0) for data tones on the first subcarrier of the resource grid 600. The second DMRS pilot tone 611 (e.g., H′(1)) is transmitted on the third subcarrier of the resource grid 600, and can be used to estimate the channel response information H(2) for data tones on the third subcarrier of the resource grid 600. The third DMRS pilot tone 612 (e.g., H′(2)) is transmitted on the fifth subcarrier of the resource grid 600, and can be used to estimate the channel response information H(4) for data tones on the fifth subcarrier of the resource grid 600. The fourth DMRS pilot tone 613 (e.g., H′(3)) is transmitted on the seventh subcarrier of the resource grid 600, and can be used to estimate the channel response information H(6) for data tones on the seventh subcarrier of the resource grid 600. The fifth DMRS pilot tone 614 (e.g., H′(4)) is transmitted on the ninth subcarrier of the resource grid 600, and can be used to estimate the channel response information H(8) for data tones on the ninth subcarrier of the resource grid 600. The sixth DMRS pilot tone 615 (e.g., H′(5)) can be transmitted on the eleventh subcarrier of the resource grid 600, and can be used to estimate the channel response information H(10) for data tones on the eleventh subcarrier of the resource grid 600.

From the set of DMRS pilot tones 610-615 (e.g., H′(0), H′(1), H′(2), H′(3), H′(4), H′(5)), the corresponding channel response information can be estimated for the data tones on the same subset of subcarriers within the resource grid 600 as the DMRS pilot tones 610-615 (e.g., the estimated channel responses H(0), H(2), H(4), H(6), H(8), H(10)). The corresponding estimated channel response information can also be referred to as the channel estimates at DMRS locations, where the channel estimates may correspond to actual channel responses measured at each respective subcarrier position in the frequency domain based on a measurement of a respective one of the pilot DMRS tones 610-615 on each respective subcarrier position of a DMRS location.

The set of DMRS pilot tones 610-615 are sparsely placed within the frequency domain and do not cover every subcarrier within the resource grid 600. In some examples, the frequency domain MMSE estimator can be configured to interpolate the frequency domain channel response from the DMRS tones. For example, the frequency domain MMSE estimator can interpolate the frequency domain channel response information for data tones at non-DMRS locations, based on the DMRS pilot tones 610-615 and/or corresponding channel response information that is determined for nearby and/or adjacent DMRS locations for each subcarrier that is a non-DMRS location.

For example, the set of channel responses (H̅(1), H̅(3), H̅(5), H̅(7), H̅(9), H̅(11)) can be determined as interpolated channel responses that are not directly measured from a corresponding DMRS pilot tone 610-615 at a corresponding DMRS location for the subcarrier, but are interpolated from the set of measured channel responses (H(0), H(2), H(4), H(6), H(8), H(10)). In some cases, the interpolation may be based on MMSE filtering, linear interpolation, and/or various other interpolation techniques, etc. For example, interpolation can be performed for the channel including and/or corresponding to the subcarriers within the resource grid 600, where the interpolation is used to determine the subset of interpolated channel responses (H̅(1), H̅(3), H̅(5), H̅(7), H̅(9), H̅(11)) using one or more of the measured channel responses H(0), H(2), H(4), H(6), H(8), H(10) obtained for the DMRS pilot tones at the DMRS locations.

In some cases, for PDSCH and/or PUSCH reception based on or using the set of pilot DMRS tones 610-615 (e.g., and the corresponding measured and/or interpolated channel response information for the subcarriers within the resource grid 600), a receiver device can perform the MMSE channel estimation per precoding resource block group (PRG). A PRG can be a configured group of RBs associated with a precoded channel and/or a particular transmission layer of a precoded channel. For example, a PRG can be a configured group of two RBs, four RBs, etc., for the precoded channel and/or particular transmission layer thereof.

In some cases, the receiver can perform descrambling of the received signal in RS tones according to:

$${Y}^{′} = {H}^{′} + {W}^{′} \qquad Eq . ( 1 )$$

Here, H′ represents an input comprising the set of DMRS pilot tones (e.g., DMRS pilot tones 610-615) for the PRG, and W′ is the MMSE matrix configured to generate as output the corresponding channel estimate for every tone (e.g., every subcarrier within the PRG, including the subset of subcarriers at DMRS locations and the subset of subcarriers at non-DMRS locations). Based on the set of DMRS pilot tones and the MMSE matrix, the generated output can be the channel estimate for every tone (e.g., subcarrier) of the PRG or resource grid 600.

To determine or obtain the MMSE channel estimation matrix W′, the FD correlation of the reference signal tones (e.g., DMRS tones 610-615) may be determined, with estimation of the FD correlations performed per PRG. Based on an RRC configuration, the PRG may include a configured number of RBs (e.g., 2, 4, etc.). For example, a PRG with 4 RBs can correspond to each PRG including 4 RBs with a total of 48 data tones. For each PRG, a first FD correlation information R_{H′H′} can be determined as the set of FD correlations calculated between the reference tones of the PRG. A second FD correlation information R_{HH′} can be determined as the set of FD correlations calculated between a data tone of the PRG (e.g., H) and a DMRS reference tone of the PRG (e.g., H′), where the second FD correlation information R_{HH′} is based at least in part on the interpolation between the channel estimates measured for the DMRS tones at the DMRS locations.

In some aspects, the descrambling of the received signal in the DMRS tones is based on and/or corresponds to Y′=H′+W′, as noted above in Eq. (1). In some aspects, an FD channel estimation can be determined as:

$$H = {{R}_{{HH}^{′}} ( {R}_{{H}^{′} {H}^{′}} + {σ}_{w}^{2} I )}^{- 1} {Y}^{′} \qquad Eq . ( 2 )$$

In some aspects, the MMSE channel estimator can correspond to:

$$W = {{R}_{{HH}^{′}} ( {R}_{{H}^{′} {H}^{′}} + {σ}_{w}^{2} I )}^{- 1} \qquad Eq . ( 3 )$$

The MMSE channel estimator W of Eq. (3) may be derived and/or obtained from the frequency correlation of the channel (e.g., Eq. (2)), for example using the two frequency correlation terms R_{HH′} and R_{H′H′}. As noted above, R_{HH′} can represent an FD correlation determined between a data tone channel response H (e.g., either measured corresponding to a DMRS pilot tone at a DMRS location, or interpolated at a non-DMRS location from the DMRS pilot tone measurements) and a DMRS tone channel response H′. In another example, R_{H′H′} can represent an FD correlation determined between first and second DMRS tone channel responses H′.

In some aspects, the frequency domain (FD) correlation R_{H}(f) can be obtained and/or determined for a channel based on the power delay profile (PDP) of the channel. For example, the receiving device can be a UE, which may implement the MMSE channel estimation based on measuring a time-domain PDP from the TRS. The UE can be configured to calculate a fast Fourier transform (FFT) of the PDP estimated from the time-domain TRS signal, and can determine estimated FD correlation information based on the output (e.g., in the frequency domain) of the FFT of the PDP. For example, the FD correlation R_{H}(f) can be obtained and/or determined based on the power delay profile according to:

$${R}_{H} ( f ) = \int P ( τ ) {e}^{- j 2 π f τ} d τ \qquad Eq . ( 4 )$$

Here, P(τ) represents the PDP of the channel.

In some cases, MMSE estimation techniques based on FD correlation information estimated as the FFT of the PDP from TRS signals can be associated with a periodic transmission rate of TRS. For example, TRS may be transmitted periodically at every 40 ms, among various other TRS periods, etc. In some examples, the frequency domain correlation and/or the MMSE matrix may be quantized as a function of delay spread of the PDP. For example, a PDP with a large delay spread is a relatively wide PDP, and a PDP with a small delay spread is a relatively narrow PDP. In some aspects, a PDP with a large delay spread can be associated with an FD correlation that increases with increases to the SCS. A PDP with a small delay spread can be associated with a channel that remains highly correlated in frequency (e.g., within the coherence bandwidth, which can be the frequency range where the channel is highly correlated). In some cases, for a channel with SCS greater than the coherence bandwidth, frequency diversity techniques may be needed. In some cases, the FD correlation and/or MMSE matrix may be quantized as a function of delay spread of the PDP, and a receiver (e.g., UE, etc.) can be configured to estimate the delay spread of PDP to pick the MMSE matrix accordingly for transmission and/or reception on the channel.

In some examples of channel estimation using TRS, the PDP and/or FD correlation estimated from TRS can be based on a TRS transmitted (e.g., broadcast, signaled, etc.) by a network entity (e.g., base station, gNB, etc.). In some cases, TRS signals are configured to be shared by a plurality of UEs within the wireless network, and the TRS is transmitted on a wide beam and without precoding. For example, the TRS is not precoded (e.g., a non-precoded signal using a non-precoded broadcast channel, etc.) based on the TRS being a broadcast signal from the network entity to the multiple UEs.

The non-precoded TRS may be transmitted on a relatively wide bandwidth including a plurality of OFDM symbols and subcarriers. When data precoding is applied for PDSCH (e.g., using one or more precoding matrices applied to each transmission, etc.), the beam associated with the PDSCH transmission on the precoded channel can be a relatively narrow beam. In some aspects, the beam used for PDSCH transmission on a precoded channel can be narrower (e.g., smaller in bandwidth, etc.) than the wide beam associated with the non-precoded TRS broadcast to and shared among multiple UEs in the network. In examples of data precoding and/or precoded channels, the mismatch between the non-precoded TRS bandwidth and the transmission bandwidth on the precoded channel can reduce the accuracy of channel estimation using TRS. For example, the PDP and/or FD correlation information estimated from the non-precoded, wide band TRS can be used to determine a corresponding MMSE channel estimation matrix. However, the MMSE channel estimation matrix determined from the PDP and/or FD correlation of the non-precoded, wide band TRS may be inaccurate for the relatively narrow band of the beam associated with the PDSCH transmission on the precoded channel. The FD correlation or PDP estimated from a non-precoded, wide TRS may not match the true, underlying FD correlation or PDP estimation in DMRS or PDSCH.

In examples where a PDP and/or FD correlation is estimated from a relatively wide band non-precoded TRS, the channel estimation determined using the PDP and/or FD correlation may be inaccurate when the channel estimation is performed for a relatively narrow band channel having a bandwidth narrower than that of the relatively wide band TRS. For example, channel estimation information determined for a relatively narrow band DMRS or PDSCH transmission on a precoded channel may be inaccurate when using a PDP or FD correlation estimated from a relatively wide band TRS, based on the DMRS or PDSCH of the precoded channel being much narrower than the TRS, and/or based on the DMRS/PDSCH transmission being precoded while the TRS is a non-precoded broadcast signal.

Precoded channels can also be associated with multiple different transmission layers, for example where each transmission layer corresponds to a path between a different combination of a transmit antenna or antenna port of the transmitting device, and a receive antenna or antenna port of the receiving device. The different transmission layers of a precoded channel can correspond to different FD correlations and/or PDPs, based on different multipath channel characteristics over the different transmission layers of the precoded channel, and the use of a single FD correlation and/or PDP for each of the different transmission layers of the precoded channel may be associated with further inaccuracy in the channel estimation from TRS (e.g., estimation of an MMSE channel estimation matrix from the PDP or FD correlation determined from TRS).

In some aspects, the systems and techniques described herein can be used to provide FD correlation information signaling for multiple transmission layers associated with a precoded channel, where the per-layer FD correlation indication of the signaling can be used to improve the accuracy of channel estimation(s) performed by a receiver using the FD correlation information. For example, the per-layer FD correlation indication can improve the channel estimation based on reducing and/or mitigating the mismatch that can be present between FD correlation and/or PDP estimated from a wide band non-precoded TRS, and a narrow band DMRS, PDSCH, etc., on the precoded channel with the multiple transmission layers.

In one illustrative example, the systems and techniques can be used for PDP and/or FD correlation estimation at a transmitter associated with a precoded channel with a plurality of transmission layers over a plurality of PRGs. For example, in a time-division duplexing (TDD) system, a network entity (e.g., base station, gNB, etc.) may be the transmitter, and the network entity can estimate the downlink channel from SRS assuming channel reciprocity. A UE may be the transmitter, and the UE can estimate the uplink channel from CSI-RS. In some aspects, the transmitter can be configured to determine a particular precoding matrix and/or precoding scheme P for use on the channel (e.g., downlink channel in examples where the transmitter is a base station or gNB, uplink channel in examples where the transmitter is a UE, etc.).

For example, the selected precoding P may be SVD or codebook-based precoding, among various others. Based on the selected and/or configured precoding P for the channel, the transmitter can determine the FD correlation or PDP of the precoded channel represented as:

$$\overline{H} ( k ) = H ( k ) P ( k ) \qquad Eq . ( 5 )$$

In the example of Eq. (5), the term H̅(k) represents the precoded channel, which can be determined as a product of the estimated channel H(k) and the selected or configured precoding P(k). As noted above, in examples where the transmitter is a base station or other network entity, the estimated channel H(k) can be the downlink channel and can be estimated from SRS. In examples where the transmitter is a UE, the estimated channel H(k) can be the uplink channel and may be estimated from CSI-RS.

For a precoded channel associated with a plurality of transmission layers, the FD correlation for the l-th layer can be determined based on:

$${R}_{\overline{HH} , l} [ k ] = {\sum }_{r} {\sum }_{PRG} 1 / N ( k ) {\sum }_{m} {\overline{H}}_{r , l} ( k + m ) {\overline{H}}_{r , l} * ( m ) \qquad Eq . ( 6 )$$

Here, R_{H̅H̅,l} is the FD correlation for the l-th layer of a precoded channel associated with a plurality of transmission layers. The term k is an offset value used to configure the FD correlation calculation, the term r represents a number of receive antenna ports associated with the precoded channel (and/or a respective MIMO configuration of the precoded channel), the term PRG represents the number of PRGs for the layer l, the term N represents the number of tones in a PRG, and H̅_{r,l} is the precoded channel corresponding to a receive antenna r and the l-th transmission layer.

The offset term k can correspond to an offset between the respective set of tones m for which the FD correlation information is determined. For example, the FD correlation of Eq. (6) averages the summation across the respective precoded channels H̅_{r,1}(k+m)H̅_{r,l}*(m), where the offset term k configures the set of different tone pairs for which averaging is performed in determining the FD correlation for the l-th layer. For example, for m=48 tones per PRG, an offset of k=0 can correspond to 48 different pairs of tones for the FD correlation averaging (e.g., tone m to tone m for all 48 tones m). An offset of k=1 can correspond to 47 different pairs of tones for the FD correlation averaging, based on the FD correlations [m+1, m], [m+2, m+1], [m+3, m+2], . . . , etc., for the 47 possible pairs within the range of m. An offset of k=2 can correspond to 46 different pairs of tones for the FD correlation averaging, based on the FD correlations [m+2, m], [m+3, m+1], [m+4, m+2], . . . , for the 46 possible pairs within the range of m, etc.

Based on determining the FD correlation for each transmission layer l of the precoded channel (e.g., the per-layer FD correlation R_{H̅H̅,l} for the l-th layer, as in Eq. (6)), the transmitter can be configured to signal the FD correlation per transmission layer of the precoded channel to a receiver. As noted above, different layers/of a precoded channel may have different FD correlations. Determining the per-layer FD correlation information R_{H̅H̅,l} of Eq. (6), and configuring the transmitter to signal and/or indicate the FD correlation per layer to the receiver can improve the channel estimation performed for the precoded channel by the receiver.

In one illustrative example, the transmitter may be configured to determine the average FD correlation across the PRGs of the precoded channel, and can signal the average FD correlation over PRGs to the receiver for determining and/or selecting a corresponding channel estimation matrix to be used by the receiver for transmission and/or reception on the precoded channel. For example, the precoded channel can be associated with a plurality of transmission layers, where each transmission layer includes one or more PRGs. The number of PRGs can be greater than or equal to the number of transmission layers of the precoded channel, and the determination of the average FD correlation across the PRGs can correspond to the summation of the individual FD correlation determined for individual PRGs divided by the total number of PRGs (e.g., the summation term in Eq. (6) indexed by the term PRG).

In some cases, the systems and techniques can be configured to determine the average FD correlation across allocated PRGs (e.g., a subset of the plurality of PRGs, where the subset of PRGs comprises the allocated PRGs mapped to and/or associated with the l-th transmission layer, etc.). In some examples, the FD correlation can be averaged across the quasi-collocated (QCL'ed) receive (Rx) antennas for the precoded channel and/or for the l-th transmission layer of the precoded channel. For example, the QCL'ed Rx antennas can be a subset of the plurality of Rx antennas r of Eq. (6), where the subset of antennas of the plurality of Rx antennas r corresponds to the receive antennas or receive antenna ports that have a QCL relationship. In some aspects, the FD correlation information across PRGs of the precoded channel is averaged across allocated PRGs and the QCL'ed Rx antennas.

In one illustrative example, the systems and techniques can be used to determine averaged FD correlation information across allocated PRGs and/or QCL'ed Rx antennas, where the averaged FD correlation information includes and/or corresponds to determining one FD correlation per transmission layer of the plurality of transmission layers of the precoded channel, and per Rx panel of QCL'ed Rx antennas. For example, the plurality of Rx antennas r associated with the precoded channel can comprise one or more subsets of antennas, where the subsets of antennas are included in different respective Rx panels of antennas. The antennas of a respective Rx panel can be QCL'ed with one another. In some cases, each subset of QCL'ed Rx antennas may be a subset of the plurality of Rx antennas r that are provided on and/or associated with the same Rx panel. In some aspects, the average FD correlation information for a particular transmission layer is the average FD correlation for the PRGs allocated to the particular transmission layer, and a respective average FD correlation for the particular transmission layer is calculated for each different Rx panel of QCL'ed Rx antennas. For example, 3 transmission layers and 4 Rx panels of QCL'ed antennas r can correspond to determining a set of 12 different averaged FD correlations for the pairs: (layer 1, Rx panel 1), (layer 1, Rx panel 2), (layer 1, Rx panel 3), (layer 1, Rx panel 4); (layer 2, Rx panel 1), (layer 2, Rx panel 2), (layer 2, Rx panel 3), (layer 2, Rx panel 4); (layer 3, Rx panel 1), (layer 3, Rx panel 2), (layer 3, Rx panel 3), (layer 3, Rx panel 4). In another example, the FD correlation can be determined as a single averaged FD correlation per layer, based on averaging the respective FD correlation for a layer across each of the different Rx panels of QCL'ed Rx antennas.

In some aspects, the averaged FD correlation information for a transmission layer and/or combination of transmission layer and Rx panel of QCL'ed Rx antennas may be quantized, to obtain a quantized value determined based on the average FD correlation information for each transmission layer. In some aspects, the transmitter can quantize the average FD correlation information for each transmission layer based on a quantization configuration. For example, the quantization configuration can correspond to performing quantization of the average FD correlation per layer with a subset of FD correlations, where the quantized value is determined based on comparing the average FD correlation for a particular layer with each candidate FD correlation in the subset, and selecting the candidate FD correlation that is closest to the average FD correlation for the particular layer.

In some cases, the systems and techniques can configure the transmitter to signal the FD correlation information for each transmission layer as the calculated averaged FD correlation per transmission layer determined according to Eq. (6). For example, the signaling can include a respective matrix of values corresponding to (e.g., indicative of) the average FD correlation information for each transmission layer l, of the plurality of transmission layers included in and/or associated with the precoded channel.

In some examples, the transmitter can signal the average FD correlation information for each transmission layer as a quantized value, where the signaling includes the quantized value and does not include the average FD correlation information determined for each layer l according to Eq. (6). The quantized value included in the signaling for each transmission layer l can be a quantized value that is indicative of the average FD correlation information for the layer l, and the receiver can use the quantized value to determine and/or obtain the corresponding average FD correlation for the l-th transmission layer based on receiving the signaling of the quantized values per layer from the transmitter. In some cases, the signaling includes a quantized value per transmission layer that is determined by the transmitter based on a comparison between the average FD correlation information determined according to Eq. (6), and each candidate FD correlation of a plurality of FD correlations associated with the quantization configuration. The quantization configuration can include the set of the plurality of candidate FD correlations, and/or the quantization configuration can be indicative of the plurality of candidate FD correlations (e.g., based on the quantization information including information the receiver can use to calculate, determine, obtain, etc., the quantization candidates locally at the receiver, etc.).

In another illustrative example, the systems and techniques can be used to provide and/or perform quantization of FD correlation information determined for a precoded channel. For example, the average FD correlation information determined for each transmission layer of the precoded channel can be quantized by determining a corresponding quantized value indicative of the average FD correlation information for the transmission layer. The corresponding quantized value can be determined from a plurality of candidate FD correlations indicated by a quantization configuration. In some cases, quantization can be performed based on average FD correlation information that is determined per transmission layer of the precoded channel and/or per Rx panel or group of QCL'ed Rx antennas associated with the precoded channel, for example using Eq. (6) above.

In some aspects, quantization can be performed by selecting a quantized value that comprises or is mapped to a candidate FD correlation (selected from a plurality of candidate FD correlations) that is closest to the average FD correlation determined for a transmission layer. The quantization based on finding the closest candidate FD correlation from a plurality of candidate FD correlations reduces the space of possible FD correlations to be signaled for the transmission layers to a reduced number of possibilities (e.g., only a selection from the plurality of candidate FD correlations will be signaled per transmission layer).

In another example, quantization can be performed as a function of the PDP. For example, the quantized value for each transmission layer of the plurality of transmission layers can be determined as a particular PDP delay spread value that is selected from a plurality of candidate PDP delay spread values. In the previous example, quantization was performed by selecting a best or closest matching candidate from a plurality of FD correlation candidates. In this example, quantization may be performed by selecting a best or closest matching candidate from a plurality of PDP delay spread (e.g., PDP window size/length) candidates. For example, PDP can be a time domain representation of FD correlation, and FD correlation can be a frequency domain representation of PDP. For a configured set of PDP delay spread candidates, where each PDP delay spread candidate corresponds to a different delay spread value (e.g., width or duration of the PDP window having the PDP delay spread), each PDP delay spread candidate also corresponds to a different FD correlation when transformed to the frequency domain.

In one illustrative example, the configured set of PDP delay spread candidates can comprise a plurality of PDP delay spread candidate values for a PDP window of a configured shape (e.g., rectangular, etc.). A set of quantization candidates can be determined as the respective FD correlation of a PDP window with each of the PDP delay spread candidate values. For example, a set of 10 PDP delay spread candidates can correspond to 10 FD correlations transformed from the PDP using a respective one of the 10 PDP delay spread candidates.

The FD correlations of the PDP windows with different PDP delay spread candidate values can also be referred to as quantization FD correlations, or quantized FD correlations from the PDP windows with different maximum delay spreads. The different quantized FD correlations associated with the different maximum PDP delay spread values can be used to quantize the average FD correlation information determined for each transmission layer of the precoded channel, for example based on comparing each average FD correlation to the set of quantized FD correlation candidates transformed from the PDP delay spread values. In some aspects, the transmitter can determine the average FD correlations per layer of the precoded channel according to Eq. (6), and may determine average FD correlation information across PRGs and Rx antennas in an Rx panel (e.g., QCL'ed Rx antennas).

From the set of respective quantized FD correlation candidates obtained as the respective FFT of a PDP window with each respective PDPD delay spread candidate value of the set of PDP delay spread candidate values for quantization, the transmitter can be configured to compare the average FD correlation information of each layer with each of the respective quantized FD correlation candidates to find a best or closest match quantized FD correlation candidate for each transmission layer. The respective quantized FD correlation candidate selected for each transmission layer can be associated with the smallest or minimum difference between the average FD correlation information for the transmission layer, and the respective quantized FD correlation candidate that is selected. In some cases, the respective quantized FD correlation corresponding to each candidate PDP delay spread value is a frequency domain representation of a PDP window with a time domain length equal to the PDP delay spread value, and a difference between the average FD correlation information and the respective quantized FD correlation determined as the quantized value for each transmission layer is less than a configured threshold associated with the quantization configuration. For example, the configured threshold can be used to select the quantized FD correlation that is closest to the average FD correlation for a respective transmission layer, or that minimizes the difference to or from the average FD correlation for the respective transmission layer, etc.

The closest matching quantized FD correlation for the average FD correlation of a transmission layer can be mapped back to the underlying PDP window delay spread value included in the set of the plurality of PDP window delay spread candidates. The PDP window delay spread candidate may be associated with a smaller and/or more compact data representation (e.g., in number of bits, etc.) than the corresponding FD correlation comprising the FFT of the PDP window with the delay spread candidate value configured as the PDP window length. In one illustrative example, the quantized value for each transmission layer's determined average FD correlation information can be signaled from the transmitter to the receiver as the selected PDP delay spread value from the plurality of PDP delay spread candidates that has the corresponding FD correlation transformation that is nearest or closest to (e.g., minimum difference with or from) the average FD correlation information determined for the transmission layer.

In some aspects, the average FD correlations per transmission layer may be quantized using a configured or default PDP window shape, and with different maximum delay spread values given according to the set of the plurality of PDP window delay spread candidates. In some examples, the transmitter is configured to perform quantization based on determining the best or optimal delay spread such that the FFT of the configured PDP window shape using the selected delay spread matches the estimated PDP window obtained as the IFFT (e.g., inverse FFT) of the average FD correlation information estimated using Eq. (6) for the particular transmission layer. In some cases, the estimated delay spread comprising the quantized value signaled for each transmission layer's corresponding average FD correlation information may itself be further quantized. For example, the signaling can include a quantized value comprising the PDP window delay spread for each layer's average FD correlation, or in some aspects, the signaling can include a quantized value that comprises a quantized PDP window delay spread. The quantized PDP window delay spread can indicate the corresponding PDP window delay spread that can be used to determine a corresponding average FD correlation information for each transmission layer.

In one illustrative example, the transmitter device (e.g., network entity and/or UE) can be configured to provide signaling to a receiver device, where the signaling includes and/or indicates a precoded channel FD correlation indication (e.g., FD correlation indication for a precoded channel). For example, the transmitter can provide signaling corresponding to the precoded channel transmission layer FD correlation information, based on including a respective FD correlation indication for each transmission layer of the plurality of transmission layers of the precoded channel. In some cases, the signaling includes an indication of a respective PDP delay spread value for each transmission layer of the plurality of transmission layers, and the respective PDP delay spread value corresponds to a quantized FD correlation indicative of the average FD correlation information (e.g., as noted above).

In some examples, the maximum delay spread information indicative of the average FD correlation information for each transmission layer of the precoded channel can be indicated in a DCI from a transmitter comprising a network entity (e.g., base station, gNB, etc.) to a receiver comprising a UE. In some aspects, the maximum delay spread information indicative of the average FD correlation information for each transmission layer of the precoded channel can be indicated in uplink control information (UCI) from a transmitter comprising a UE and a receiver comprising a network entity.

In some examples, the maximum delay spread information indicative of the average FD correlation information for each transmission layer of the precoded channel can be indicated in a MAC-CE and/or RRC configuration transmitted from the transmitter to the receiver. For a precoded downlink channel, the transmitter may be a network entity (e.g., base station, gNB, etc.), and the maximum delay spread information can be signaled or indicated in DCI. In one illustrative example, the delay spread information can be indicated as a selection from a configured (e.g., finite, etc.) set of candidate delay spread values. For example, the delay spread information can be indicated as the value of the selected candidate delay spread. In some aspects, further quantization of the candidate delay spreads can be performed, for example by signaling an index value to represent the selected candidate delay spread from the plurality of candidate delay spreads (e.g., signaling an index to the position of the selected candidate delay spread value in the set or listing of the plurality of candidate delay spread values, instead of signaling the selected candidate delay spread value itself).

In some cases, the precoded channel is a precoded uplink channel, where the transmitter is a UE and the receiver is a network entity (e.g., base station, gNB, etc.). In some aspects, for uplink signaling of average FD correlation information to the base station, the UE can be configured to indicate the maximum delay spread information in UCI, the same as or similar to the maximum delay spread information indicated in DCI by a network entity transmitter for a precoded downlink channel.

In some examples, L2 and/or L3 signaling may be used for examples where a UE transmitter or receiver device is relatively stationary. For example, the corresponding network entity (e.g., base station, gNB, etc.) may use the same SVD precoder within an SRS period, and MAC-CE signaling can be used to indicate a set of delay spreads for all of the transmission layers associated with the SVD precoded channel. In some examples, where the gNB is configured to perform rank adaptation, the gNB can be configured to transmit a DCI to indicate a particular subset of transmission layers (e.g., of the plurality of transmission layers of the SVD precoded channel) that are scheduled, and the corresponding delay spread indicative of the quantized average FD correlation information for each transmission layer of the subset of transmission layers scheduled to be used for the SVD precoded channel. In some examples, for a maximum or threshold number of transmission layers of the precoded channel, the DCI can indicate a bitmap having a number of bits equal to the maximum or threshold number of transmission layers. For example, for a maximum of four transmission layers for the SVD precoded channel, the DCI indicative of the subset of transmission layers that are scheduled, and/or the corresponding delay spread indicating the quantized average FD correlation information for each transmission layer of the subset of scheduled transmission layers, may be indicated in the DCI as a 4-bit bitmap.

In some aspects, the precoded channel average FD correlation indication can be implemented as quantized average FD correlation information per transmission layer of the precoded channel. In some examples, the average FD correlation can be quantized with the PDP window delay spread values corresponding to different PDP window lengths (e.g., widths), which are time-domain representations of different respective FD correlations when transformed to the frequency-domain. In some aspects, the quantization based on PDP window delay spreads can be performed using a PDP delay spread time granularity of approximately 10 nanoseconds (ns), 25 ns, 50 ns, 100 ns, etc., noting that various other PDP delay spread time granularity values may also be used. In some cases, for a maximum delay spread threshold value that is less than or equal to 1000 ns, the per-layer delay spread values may be quantized using 3 bits (e.g., where 3-bit quantization can represent 23=8 different quantized candidates, corresponding to equally spaced quantized off the maximum delay spread values <1000 ns into one of the 8 different quantization candidate ranges, which may be symmetric or asymmetric within the total delay spread range <1000 ns).

In one illustrative example, FD correlation or delay spread indications in the signaling from the transmitter to the receiver for each transmission layer of the precoded channel may be signaled on a per-layer basis, with different transmission layers of the precoded channel having different delay spreads. In some aspects, the per-layer FD correlation quantized as a PDP window delay spread value may itself be further quantized, for example into a configured number of bits, X, to represent the PDP window delay spread value. In some aspects, the number of bits X for quantizing the PDP window delay spread quantization values can be configured as X=3. In some examples, the systems and techniques can be used to reduce signaling overhead for DCI and/or UCI transmission indicative of the average FD correlation information for each transmission layer (e.g., DCI from a transmitter comprising a network entity (e.g., base station, gNB, etc.), UCI from a transmitter comprising a UE, etc.).

For example, DCI and/or UCI overhead for the signaling can be reduced based on using a differential encoding for the delay spreads of additional transmission layers associated with the precoded channel, where the additional transmission layers are the transmission layers other than the first transmission layer associated with the precoded channel. The quantized PDP window delay spread for the remaining, additional transmission layers (e.g., after the first transmission layer of the precoded channel) can be indicated using differential encoding relative to the PDP window delay spread for the first transmission layer. For example, the first transmission layer can be associated with a PDP window delay spread indication using X bits, the second transmission layer can be associated with a PDP window delay spread indication differentially encoded relative to the first transmission layer using fewer than X bits, the third transmission layer can be associated with a PDP window delay spread indication differentially encoded relative to the first transmission layer using fewer than X bits, . . . , etc. For example, the difference in PDP delay spread between two consecutive transmission layer (e.g., first and second, second and third, third and fourth transmission layers, . . . , etc.) may be configured to be no greater than 150 ns (e.g., a threshold inter-layer difference of 150 ns maximum for pairs of adjacent transmission layers). For a 150 ns or less inter-layer difference between PDP delay spread values, the differential encoding can be implemented to use 2 bits or less for a differentially encoded quantized representation of the additional or remaining transmission layers after the first transmission layer of the precoded channel, where the first transmission layer is quantized using X=3 bits.

In some cases, the receiver of the signaling indicative of the average FD correlation information per transmission layer can implement channel estimation adjustments per layer, using the corresponding average FD correlation information determined from the signaling. For example, the receiver can receive the per-layer average FD correlation or PDP delay spread information for each transmission layer of the precoded channel. The receiver can determine one or more adjustments of the per-layer MMSE channel estimation matrices, based on the indicated per-layer FD correlation information (quantized or non-quantized) indicated for each transmission layer of the plurality of transmission layers of the precoded channel, based on the received signaling.

In some aspects, the receiver can adjust the MMSE channel estimation matrix for each transmission layer of the precoded channel, based on the indicated per-layer FD correlation or PDP window delay spread indicated for each transmission layer within the signaling. For example, for the l-th transmission layer, the receiver can use the indicated (e.g., received) FD correlation and/or PDP window delay spread from the signaling of the transmitter to determine a corresponding MMSE matrix or MMSE matrix update as:

$${W}_{l} = {{R}_{{\overline{HH}}^{′} , l} ( {R}_{{\overline{H}}^{′} {\overline{H}}^{′} , l} + {σ}_{w}^{2} I )}^{- 1} \qquad Eq . ( 7 )$$

The MMSE matrix for the l-th layer is represented as Wₗ, R_{H̅H̅′,l}, and R_{H̅′H̅′,l} correspond to the FD correlation information indicated by the quantized FD correlation value and/or quantized PDP delay spread value and/or non-quantized PDP delay spread value indicated in the received signaling for each respective layer l of the plurality of transmission layers within the precoded channel.

In some aspects, the channel estimation matrices Wₗ can be determined by the receiver as a function of delay spread indications (e.g., PDP window delay spread values, quantized and/or non-quantized) of multiple layers. In some examples, the receiver can be configured to determine a corresponding channel estimation matrix as a selection from a configured plurality of candidate channel estimation matrices based at least in part on the number of transmission layers for the precoded channel and the quantized PDP delay spread (and/or corresponding average per-layer FD correlation information indicated by and/or mapped to the quantized PDP delay spread value) indicated by the signaled from the transmitter device.

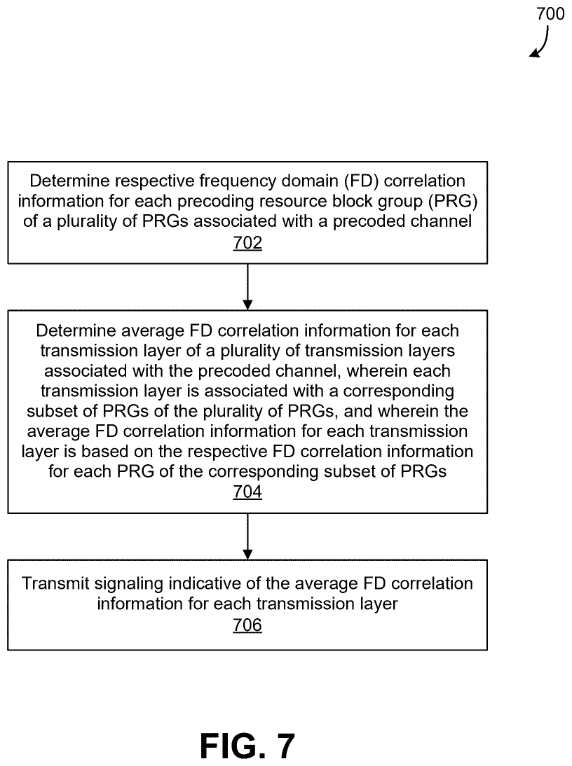

FIG. 7 is a flowchart diagram illustrating an example of a process 700 for wireless communications. In some aspects, the process 700 can be a process for wireless communications by a network entity (e.g., a UE, etc.). For example, the process 700 can be a process for wireless communications by a UE. In some examples, the process 700 can be performed by a network entity or network device (or apparatus) or a component (e.g., a chipset, codec, etc.) of the network entity or device. The process 700 can be performed by one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the network entity or device or apparatus. The operations of the process 700 may be implemented as software components that are executed and run on one or more processors (e.g., processor 910 and/or processing system 902 of FIG. 9, or other processor(s)). The process 700 may be performed by a network entity or network device (or apparatus) or a component (e.g., a chipset, codec, etc.) of the network entity or device. In some examples, the network entity and/or device may be a transmitter configured to and/or capable of transmitting one or more wireless signals using a wireless communication network. For example, the network entity and/or device may be a UE, and/or may be a base station (e.g., eNB, gNB, etc.).

In some examples, the process 700 can be performed by a UE, including any of the various UEs described herein. In some aspects, the process 700 can be performed by a UE, smartphone, mobile computing device, user computer device, etc. The process 700 can be performed by a component or system (e.g., a chipset) of a network device (e.g., one or more of UEs 104, 152, 164, 182, 190 of FIG. 1; UE 104 of FIG. 2; UE(s) 104 of FIG. 3; wireless device 407 of FIG. 4; computing system 900 and/or processing system 902 of FIG. 9; etc.). The network device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.). Further, the transmission and reception of signals by the network entity in the process 700 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

At block 702, the network entity (or component thereof) can determine respective frequency domain (FD) correlation information for each precoding resource block group (PRG) of a plurality of PRGs associated with a precoded channel. For example, the respective FD correlation information can be determined for one or more PRGs associated with the time-frequency resource grid 600 of FIG. 6.

At block 704, the network entity (or component thereof) can determine average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs.

For example, average FD correlation information for each transmission layer can be an average of the respective FD correlation information for each PRG of the corresponding subset of PRGs. In some cases, the precoded channel can be associated with a plurality of receive antennas corresponding to a multiple input-multiple output (MIMO) configuration for the precoded channel. The respective FD correlation information for each PRG can include a respective FD correlation determined for the PRG and each receive antenna of the plurality of receive antennas.

In some cases, the network entity (or component thereof) can be configured to quantize the average FD correlation information for each transmission layer based on a quantization configuration. The signaling can be indicative of a quantized value determined based on the average FD correlation information for each transmission layer. In some cases, the network entity (or component thereof) can be configured to determine the quantized value for a particular transmission layer of the plurality of transmission layers based on a comparison between the average FD correlation information for the particular transmission layer and each candidate FD correlation of a plurality of candidate FD correlations associated with the quantization configuration.

In some examples, the quantized value for each transmission layer of the plurality of transmission layers can comprise one or more quantization bits mapped to a particular quantization candidate of a plurality of quantization candidates according to the quantization configuration. In some cases, the signaling may include a respective quantized value indicative of the average FD correlation information for each transmission layer based on a mapping between the respective quantized value and a particular quantization candidate of a plurality of quantization candidates. A difference between the particular quantization candidate and the average FD correlation information for each transmission layer can be less than a configured threshold associated with the quantization configuration.

In some examples, the quantized value for each transmission layer of the plurality of transmission layers is a power delay profile (PDP) delay spread value determined from a plurality of candidate PDP delay spread values. In some cases, the respective quantized FD correlation corresponding to each candidate PDP delay spread value can be a frequency domain representation of a PDP window with a time domain length equal to the PDP delay spread value. A difference between the average FD correlation information and the respective quantized FD correlation can be determined as the quantized value for each transmission layer is less than a configured threshold associated with the quantization configuration.

In some examples, the network entity (or component thereof) can be configured to determine the quantized value for each transmission layer based on a comparison between the average FD correlation information and a respective quantized FD correlation corresponding to each candidate PDP delay spread value of the plurality of candidate PDP delay spread values. In some cases, the quantization configuration can be indicative of at least one of: one or more configurations for a power delay profile (PDP) window corresponding to quantized FD correlation information, or a maximum PDP delay spread value corresponding to quantized FD correlation information.

At block 706, the network entity (or component thereof) can transmit signaling indicative of the average FD correlation information for each transmission layer. For example, the signaling can include a respective matrix of values corresponding to the average FD correlation information for each transmission layer. In some cases, the signaling may include an indication of a respective power delay profile (PDP) delay spread value for each transmission layer of the plurality of transmission layers, and the respective PDP delay spread value can correspond to a quantized FD correlation indicative of the average FD correlation information.

In some examples, the signaling can include at least one of downlink control information (DCI) signaling, uplink control information (UCI) signaling, media access control (MAC) control element (MAC-CE) signaling, or radio resource control (RRC) configuration signaling. In some cases, the signaling can include a maximum PDP delay spread value from the respective PDP delay spread values for the plurality of transmission layers, where the signaling comprises downlink control information (DCI) signaling or uplink control information (UCI) signaling.

In some examples, to transmit the signaling, the network entity (or component thereof) can be configured to transmit media access control (MAC) control element (MAC-CE) signaling indicative of a respective set of multiple PDP delay spread values for each transmission layer of the plurality of transmission layers, and to transmit downlink control information (DCI) signaling indicative of scheduling information for a subset of transmission layers of the plurality of transmission layers and a configured PDP delay spread value for each transmission layer of the subset, wherein the configured PDP delay spread value is included in the respective set of multiple PDP delay spread values for each transmission layer of the subset.

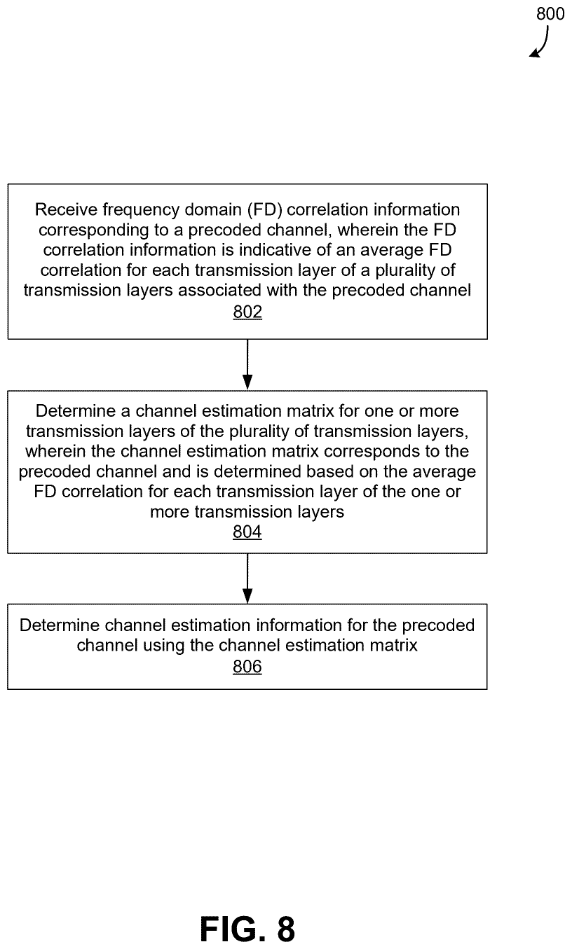

FIG. 8 is a flowchart diagram illustrating an example of a process 800 for wireless communication. The process 800 may be performed by a network entity or network device (or apparatus) or a component (e.g., a chipset, codec, etc.) of the network entity or device. In some examples, the network entity and/or device may be a receiver configured to and/or capable of receiving one or more wireless signals using a wireless communication network. For example, the network entity and/or device may be a UE, and/or may be a base station (e.g., eNB, gNB, etc.). The apparatus and/or device may be a UE (e.g., the UE 104 of FIG. 1, FIG. 2, and/or FIG. 3, the wireless device 407 of FIG. 4, or other UE). The apparatus and/or device may be a network entity (e.g., base station). In some examples, the process 800 may be performed by a network entity or network device (or apparatus) or a component (e.g., a chipset, codec, etc.) of the network entity or device. For example, the apparatus and/or device may be a network entity such as a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3), server device, or other network entity.

In some examples, the apparatus and/or device (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 800 may be implemented as software components that are executed and run on one or more processors (e.g., one or more of the transmit processor 264, the receive processor 258, the TX MIMO processor 266, the MIMO detector 256 of FIG. 2, the processing system 470 of FIG. 4, the processor(s) 484 of FIG. 4, the processing system 902 of FIG. 9, and/or the processor 910 of FIG. 9, or other processor(s) (e.g., such as one or more other processors included within and/or associated with the processing system 470 of FIG. 4, the processing system 902 of FIG. 9, etc.)). Further, the transmission and reception of signals by the apparatus and/or device in the process 800 may be enabled, for example, by one or more antennas, one or more transceivers (e.g., wireless transceiver(s)), and/or other communication components (e.g., one or more of the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 940 of FIG. 9, or other antennae(s), transceiver(s), and/or component(s)).

At block 802, the network entity (or component thereof) can receive frequency domain (FD) correlation information corresponding to a precoded channel, wherein the FD correlation information is indicative of an average FD correlation for each transmission layer of a plurality of transmission layers associated with the precoded channel.

For example, the FD correlation information can include a respective quantized FD correlation value corresponding to the average FD correlation for each transmission layer. In some cases, the network entity (or component thereof) can be configured to receive information indicative of a quantization configuration associated with the FD correlation information.

In some cases, the network entity (or component thereof) can be configured to de-quantize the respective quantized FD correlation value for each transmission layer based on the quantization configuration. For example, the FD correlation information can be included in first signaling received from an additional network entity, and the information indicative of the quantization configuration can be included in second signaling received from the additional network entity. In some cases, the FD correlation information can be included in first signaling received from an additional network entity, and the information indicative of the quantization configuration can be included in second signaling received from the additional network entity.

At block 804, the network entity (or component thereof) can determine a channel estimation matrix for one or more transmission layers of the plurality of transmission layers, wherein the channel estimation matrix corresponds to the precoded channel and is determined based on the average FD correlation for each transmission layer of the one or more transmission layers.

For example, the channel estimation matrix can be a maximum mean square error (MMSE) channel estimation matrix configured for the plurality of transmission layers and the precoded channel. In some cases, to determine the channel estimation matrix, the network entity (or component thereof) can be configured to generate one or more updates for the channel estimation matrix corresponding to the precoded channel.

At block 806, the network entity (or component thereof) can determine channel estimation information for the precoded channel using the channel estimation matrix.

In some examples, the processes described herein (e.g., process 700 and/or the process 800 and/or other process described herein) may be performed by a computing device or apparatus (e.g., a network node such as a UE, base station, a portion of a base station, etc.). For example, as noted above, the process 700 and/or the process 800 may be performed by a UE and/or network entity (e.g., base station, gNB, etc.). In some examples, the process 700 and/or the process 800 may be performed by a computing device with the computing system 900 shown in FIG. 9. For example, a wireless communication device with the computing architecture shown in FIG. 9 may include the components of the UE and/or the network entity (e.g., base station, gNB, etc.) and may implement the operations of FIG. 7 and/or process 700, and/or the operations of FIG. 8 and/or the process 800, etc.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 and the process 800 are illustrated as logical flow diagrams, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700 and/or the process 800 and/or other process(es) described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900 including a processing system 902, which may be for example any computing device making up internal computing system, a remote computing system, a camera, or any component thereof in which the components of the system are in communication with each other using connection 905. Connection 905 may be a physical connection using a bus, or a direct connection into processor 910 (and/or one or more other processors included within and/or associated with the processing system 902), such as in a chipset architecture. Connection 905 may also be a virtual connection, networked connection, or logical connection.

In some aspects, computing system 900 and/or the processing system 902 can be provided as a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

The example processing system 902 includes at least one processing unit (CPU or processor) 910 and connection 905 that communicatively couples various system components including system memory 915, such as read-only memory (ROM) 920 and random access memory (RAM) 925 to processor 910. The processing system 902 may include a cache 912 of high-speed memory connected directly with, in close proximity to, or integrated as part of processor 910 and/or one or more other processors included within and/or associated with the processing system 902.

Processor 910 may include any general-purpose processor and a hardware service or software service, such as services 932, 934, and 936 stored in storage device 930, configured to control processor 910 and/or one or more other processors included within and/or associated with the processing system 902, as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, processing system 902 includes an input device 945, which may represent any number of input mechanisms, such as a microphone for speech, a touch-sensitive screen for gesture or graphical input, keyboard, mouse, motion input, speech, etc. Processing system 902 may also include output device 935, which may be one or more of a number of output mechanisms. In some examples, multimodal systems may enable a user to provide multiple types of input/output to communicate with processing system 902.

Processing system 902 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910 and/or one or more other processors included within and/or associated with the processing system 902, it causes the system to perform a function. In some aspects, a hardware service that performs a particular function may include the software component stored in a computer-readable medium in connection with the necessary hardware components, such as processor 910 (e.g., and/or one or more other processors included within and/or associated with the processing system 902), connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some examples the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other examples, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A network entity for wireless communication, comprising: a processing system configured to: determine respective frequency domain (FD) correlation information for each precoding resource block group (PRG) of a plurality of PRGs associated with a precoded channel; determine average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and transmit signaling indicative of the average FD correlation information for each transmission layer.

Aspect 2. The network entity of Aspect 1, wherein the signaling includes a respective matrix of values corresponding to the average FD correlation information for each transmission layer.

Aspect 3. The network entity of any of Aspects 1 to 2, wherein the processing system is configured to quantize the average FD correlation information for each transmission layer based on a quantization configuration, and wherein the signaling is indicative of a quantized value determined based on the average FD correlation information for each transmission layer.

Aspect 4. The network entity of Aspect 3, wherein the processing system is configured to determine the quantized value for a particular transmission layer of the plurality of transmission layers based on a comparison between the average FD correlation information for the particular transmission layer and each candidate FD correlation of a plurality of candidate FD correlations associated with the quantization configuration.

Aspect 5. The network entity of any of Aspects 3 to 4, wherein: the quantized value for each transmission layer of the plurality of transmission layers comprises one or more quantization bits mapped to a particular quantization candidate of a plurality of quantization candidates according to the quantization configuration.

Aspect 6. The network entity of any of Aspects 3 to 5, wherein: the signaling includes a respective quantized value indicative of the average FD correlation information for each transmission layer based on a mapping between the respective quantized value and a particular quantization candidate of a plurality of quantization candidates; and a difference between the particular quantization candidate and the average FD correlation information for each transmission layer is less than a configured threshold associated with the quantization configuration.

Aspect 7. The network entity of any of Aspects 3 to 6, wherein the quantized value for each transmission layer of the plurality of transmission layers is a power delay profile (PDP) delay spread value determined from a plurality of candidate PDP delay spread values.

Aspect 8. The network entity of Aspect 7, wherein: the respective quantized FD correlation corresponding to each candidate PDP delay spread value is a frequency domain representation of a PDP window with a time domain length equal to the PDP delay spread value; and a difference between the average FD correlation information and the respective quantized FD correlation determined as the quantized value for each transmission layer is less than a configured threshold associated with the quantization configuration.

Aspect 9. The network entity of any of Aspects 7 to 8, wherein the processing system is configured to determine the quantized value for each transmission layer based on a comparison between the average FD correlation information and a respective quantized FD correlation corresponding to each candidate PDP delay spread value of the plurality of candidate PDP delay spread values.

Aspect 10. The network entity of any of Aspects 3 to 9, wherein the quantization configuration is indicative of at least one of: one or more configurations for a power delay profile (PDP) window corresponding to quantized FD correlation information, or a maximum PDP delay spread value corresponding to quantized FD correlation information.

Aspect 11. The network entity of any of Aspects 1 to 10, wherein the signaling includes an indication of a respective power delay profile (PDP) delay spread value for each transmission layer of the plurality of transmission layers, and wherein the respective PDP delay spread value corresponds to a quantized FD correlation indicative of the average FD correlation information.

Aspect 12. The network entity of Aspect 11, wherein the signaling includes at least one of downlink control information (DCI) signaling, uplink control information (UCI) signaling, media access control (MAC) control element (MAC-CE) signaling, or radio resource control (RRC) configuration signaling.

Aspect 13. The network entity of any of Aspects 11 to 12, wherein the signaling includes a maximum PDP delay spread value from the respective PDP delay spread values for the plurality of transmission layers, and wherein the signaling comprises downlink control information (DCI) signaling or uplink control information (UCI) signaling.

Aspect 14. The network entity of any of Aspects 11 to 13, wherein, to transmit the signaling, the processing system is configured to: transmit media access control (MAC) control element (MAC-CE) signaling indicative of a respective set of multiple PDP delay spread values for each transmission layer of the plurality of transmission layers; and transmit downlink control information (DCI) signaling indicative of scheduling information for a subset of transmission layers of the plurality of transmission layers and a configured PDP delay spread value for each transmission layer of the subset, wherein the configured PDP delay spread value is included in the respective set of multiple PDP delay spread values for each transmission layer of the subset.

Aspect 15. The network entity of any of Aspects 1 to 14, wherein the average FD correlation information for each transmission layer is an average of the respective FD correlation information for each PRG of the corresponding subset of PRGs.

Aspect 16. The network entity of Aspect 15, wherein: the precoded channel is associated with a plurality of receive antennas corresponding to a multiple input-multiple output (MIMO) configuration for the precoded channel; and the respective FD correlation information for each PRG includes a respective FD correlation determined for the PRG and each receive antenna of the plurality of receive antennas.

Aspect 17. A network entity for wireless communication, comprising: a processing system configured to: receive frequency domain (FD) correlation information corresponding to a precoded channel, wherein the FD correlation information is indicative of an average FD correlation for each transmission layer of a plurality of transmission layers associated with the precoded channel; determine a channel estimation matrix for one or more transmission layers of the plurality of transmission layers, wherein the channel estimation matrix corresponds to the precoded channel and is determined based on the average FD correlation for each transmission layer of the one or more transmission layers; and determine channel estimation information for the precoded channel using the channel estimation matrix.

Aspect 18. The network entity of Aspect 17, wherein: the FD correlation information includes a respective quantized FD correlation value corresponding to the average FD correlation for each transmission layer; and the processing system is configured to receive information indicative of a quantization configuration associated with the FD correlation information.

Aspect 19. The network entity of Aspect 18, wherein the processing system is configured to: de-quantize the respective quantized FD correlation value for each transmission layer based on the quantization configuration.

Aspect 20. The network entity of any of Aspects 18 to 19, wherein the FD correlation information is included in first signaling received from an additional network entity, and wherein the information indicative of the quantization configuration is included in second signaling received from the additional network entity.

Aspect 21. The network entity of any of Aspects 18 to 20, wherein the FD correlation information is included in first signaling received from an additional network entity, and wherein the information indicative of the quantization configuration is included in second signaling received from the additional network entity.

Aspect 22. The network entity of any of Aspects 17 to 21, wherein the channel estimation matrix is a maximum mean square error (MMSE) channel estimation matrix configured for the plurality of transmission layers and the precoded channel.

Aspect 23. The network entity of any of Aspects 17 to 22, wherein, to determine the channel estimation matrix, the processing system is configured to generate one or more updates for the channel estimation matrix corresponding to the precoded channel.

Aspect 24. A method for wireless communication, comprising: determining respective frequency domain (FD) correlation information for each precoding resource block group (PRG) of a plurality of PRGs associated with a precoded channel; determining average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and transmitting signaling indicative of the average FD correlation information for each transmission layer.

Aspect 25. The method of Aspect 24, wherein the signaling includes a respective matrix of values corresponding to the average FD correlation information for each transmission layer.

Aspect 26. The method of any of Aspects 24 to 25, further comprising quantizing the average FD correlation information for each transmission layer based on a quantization configuration, and wherein the signaling is indicative of a quantized value determined based on the average FD correlation information for each transmission layer.

Aspect 27. The method of Aspect 26, further comprising determining the quantized value for a particular transmission layer of the plurality of transmission layers based on a comparison between the average FD correlation information for the particular transmission layer and each candidate FD correlation of a plurality of candidate FD correlations associated with the quantization configuration.

Aspect 28. The method of any of Aspects 26 to 27, wherein: the quantized value for each transmission layer of the plurality of transmission layers comprises one or more quantization bits mapped to a particular quantization candidate of a plurality of quantization candidates according to the quantization configuration.

Aspect 29. The method of any of Aspects 26 to 28, wherein: the signaling includes a respective quantized value indicative of the average FD correlation information for each transmission layer based on a mapping between the respective quantized value and a particular quantization candidate of a plurality of quantization candidates; and a difference between the particular quantization candidate and the average FD correlation information for each transmission layer is less than a configured threshold associated with the quantization configuration.

Aspect 30. The method of any of Aspects 26 to 29, wherein the quantized value for each transmission layer of the plurality of transmission layers is a power delay profile (PDP) delay spread value determined from a plurality of candidate PDP delay spread values.

Aspect 31. The method of Aspect 30, wherein: the respective quantized FD correlation corresponding to each candidate PDP delay spread value is a frequency domain representation of a PDP window with a time domain length equal to the PDP delay spread value; and a difference between the average FD correlation information and the respective quantized FD correlation determined as the quantized value for each transmission layer is less than a configured threshold associated with the quantization configuration.

Aspect 32. The method of any of Aspects 30 to 31, further comprising determining the quantized value for each transmission layer based on a comparison between the average FD correlation information and a respective quantized FD correlation corresponding to each candidate PDP delay spread value of the plurality of candidate PDP delay spread values.

Aspect 33. The method of any of Aspects 26 to 32, wherein the quantization configuration is indicative of at least one of: one or more configurations for a power delay profile (PDP) window corresponding to quantized FD correlation information, or a maximum PDP delay spread value corresponding to quantized FD correlation information.

Aspect 34. The method of any of Aspects 24 to 33, wherein the signaling includes an indication of a respective power delay profile (PDP) delay spread value for each transmission layer of the plurality of transmission layers, and wherein the respective PDP delay spread value corresponds to a quantized FD correlation indicative of the average FD correlation information.

Aspect 35. The method of Aspect 34, wherein the signaling includes at least one of downlink control information (DCI) signaling, uplink control information (UCI) signaling, media access control (MAC) control element (MAC-CE) signaling, or radio resource control (RRC) configuration signaling.

Aspect 36. The method of any of Aspects 34 to 35, wherein the signaling includes a maximum PDP delay spread value from the respective PDP delay spread values for the plurality of transmission layers, and wherein the signaling comprises downlink control information (DCI) signaling or uplink control information (UCI) signaling.

Aspect 37. The method of any of Aspects 34 to 36, wherein transmitting the signaling comprises: transmitting media access control (MAC) control element (MAC-CE) signaling indicative of a respective set of multiple PDP delay spread values for each transmission layer of the plurality of transmission layers; and transmitting downlink control information (DCI) signaling indicative of scheduling information for a subset of transmission layers of the plurality of transmission layers and a configured PDP delay spread value for each transmission layer of the subset, wherein the configured PDP delay spread value is included in the respective set of multiple PDP delay spread values for each transmission layer of the subset.

Aspect 38. The method of any of Aspects 24 to 37, wherein the average FD correlation information for each transmission layer is an average of the respective FD correlation information for each PRG of the corresponding subset of PRGs.

Aspect 39. The method of Aspect 38, wherein: the precoded channel is associated with a plurality of receive antennas corresponding to a multiple input-multiple output (MIMO) configuration for the precoded channel; and the respective FD correlation information for each PRG includes a respective FD correlation determined for the PRG and each receive antenna of the plurality of receive antennas.

Aspect 40. A method for wireless communication, comprising: receiving frequency domain (FD) correlation information corresponding to a precoded channel, wherein the FD correlation information is indicative of an average FD correlation for each transmission layer of a plurality of transmission layers associated with the precoded channel; determining a channel estimation matrix for one or more transmission layers of the plurality of transmission layers, wherein the channel estimation matrix corresponds to the precoded channel and is determined based on the average FD correlation for each transmission layer of the one or more transmission layers; and determining channel estimation information for the precoded channel using the channel estimation matrix.

Aspect 41. The method of Aspect 40, wherein: the FD correlation information includes a respective quantized FD correlation value corresponding to the average FD correlation for each transmission layer; and to the method further includes receiving information indicative of a quantization configuration associated with the FD correlation information.

Aspect 42. The method of Aspect 41, further comprising: de-quantizing the respective quantized FD correlation value for each transmission layer based on the quantization configuration.

Aspect 43. The method of any of Aspects 41 to 42, wherein the FD correlation information is included in first signaling received from an additional network entity, and wherein the information indicative of the quantization configuration is included in second signaling received from the additional network entity.

Aspect 44. The method of any of Aspects 41 to 43, wherein the FD correlation information is included in first signaling received from an additional network entity, and wherein the information indicative of the quantization configuration is included in second signaling received from the additional network entity.

Aspect 45. The method of any of Aspects 40 to 44, wherein the channel estimation matrix is a maximum mean square error (MMSE) channel estimation matrix configured for the plurality of transmission layers and the precoded channel.

Aspect 46. The method of any of Aspects 40 to 45, wherein determining the channel estimation matrix comprises generating one or more updates for the channel estimation matrix corresponding to the precoded channel.

Aspect 47. A non-transitory computer-readable storage medium comprising instructions stored thereon which, when executed by at least one processor, causes the at least one processor to perform operations according to any of Aspects 1 to 16.

Aspect 48. A non-transitory computer-readable storage medium comprising instructions stored thereon which, when executed by at least one processor, causes the at least one processor to perform operations according to any of Aspects 17 to 23.

Aspect 49. An apparatus for wireless communication comprising one or more means for performing operations according to any of Aspects 1 to 16.

Aspect 50. An apparatus for wireless communication comprising one or more means for performing operations according to any of Aspects 17 to 23.

What is claimed is:

1. A network entity for wireless communication, comprising:
a processing system configured to:
determine respective frequency domain (FD) correlation information for each precoding resource block group (PRG) of a plurality of PRGs associated with a precoded channel;
determine average FD correlation information for each transmission layer of a plurality of transmission layers associated with the precoded channel, wherein each transmission layer is associated with a corresponding subset of PRGs of the plurality of PRGs, and wherein the average FD correlation information for each transmission layer is based on the respective FD correlation information for each PRG of the corresponding subset of PRGs; and
transmit signaling indicative of the average FD correlation information for each transmission layer.

2. The network entity of claim 1, wherein the signaling includes a respective matrix of values corresponding to the average FD correlation information for each transmission layer.

3. The network entity of claim 1, wherein the processing system is configured to quantize the average FD correlation information for each transmission layer based on a quantization configuration, and wherein the signaling is indicative of a quantized value determined based on the average FD correlation information for each transmission layer.

4. The network entity of claim 3, wherein the processing system is configured to determine the quantized value for a particular transmission layer of the plurality of transmission layers based on a comparison between the average FD correlation information for the particular transmission layer and each candidate FD correlation of a plurality of candidate FD correlations associated with the quantization configuration.

5. The network entity of claim 3, wherein:
the quantized value for each transmission layer of the plurality of transmission layers comprises one or more quantization bits mapped to a particular quantization candidate of a plurality of quantization candidates according to the quantization configuration.

6. The network entity of claim 3, wherein:
the signaling includes a respective quantized value indicative of the average FD correlation information for each transmission layer based on a mapping between the respective quantized value and a particular quantization candidate of a plurality of quantization candidates; and
a difference between the particular quantization candidate and the average FD correlation information for each transmission layer is less than a configured threshold associated with the quantization configuration.

7. The network entity of claim 3, wherein the quantized value for each transmission layer of the plurality of transmission layers is a power delay profile (PDP) delay spread value determined from a plurality of candidate PDP delay spread values.

8. The network entity of claim 7, wherein:
the respective quantized FD correlation corresponding to each candidate PDP delay spread value is a frequency domain representation of a PDP window with a time domain length equal to the PDP delay spread value; and
a difference between the average FD correlation information and the respective quantized FD correlation determined as the quantized value for each transmission layer is less than a configured threshold associated with the quantization configuration.

9. The network entity of claim 7, wherein the processing system is configured to determine the quantized value for each transmission layer based on a comparison between the average FD correlation information and a respective quantized FD correlation corresponding to each candidate PDP delay spread value of the plurality of candidate PDP delay spread values.

10. The network entity of claim 3, wherein the quantization configuration is indicative of at least one of: one or more configurations for a power delay profile (PDP) window corresponding to quantized FD correlation information, or a maximum PDP delay spread value corresponding to quantized FD correlation information.

11. The network entity of claim 1, wherein the signaling includes an indication of a respective power delay profile (PDP) delay spread value for each transmission layer of the plurality of transmission layers, and wherein the respective PDP delay spread value corresponds to a quantized FD correlation indicative of the average FD correlation information.

12. The network entity of claim 11, wherein the signaling includes at least one of downlink control information (DCI) signaling, uplink control information (UCI) signaling, media access control (MAC) control element (MAC-CE) signaling, or radio resource control (RRC) configuration signaling.

13. The network entity of claim 11, wherein the signaling includes a maximum PDP delay spread value from the respective PDP delay spread values for the plurality of transmission layers, and wherein the signaling comprises downlink control information (DCI) signaling or uplink control information (UCI) signaling.

14. The network entity of claim 11, wherein, to transmit the signaling, the processing system is configured to:
transmit media access control (MAC) control element (MAC-CE) signaling indicative of a respective set of multiple PDP delay spread values for each transmission layer of the plurality of transmission layers; and
transmit downlink control information (DCI) signaling indicative of scheduling information for a subset of transmission layers of the plurality of transmission layers and a configured PDP delay spread value for each transmission layer of the subset, wherein the configured PDP delay spread value is included in the respective set of multiple PDP delay spread values for each transmission layer of the subset.

15. The network entity of claim 1, wherein the average FD correlation information for each transmission layer is an average of the respective FD correlation information for each PRG of the corresponding subset of PRGs.

16. The network entity of claim 15, wherein:
the precoded channel is associated with a plurality of receive antennas corresponding to a multiple input-multiple output (MIMO) configuration for the precoded channel; and
the respective FD correlation information for each PRG includes a respective FD correlation determined for the PRG and each receive antenna of the plurality of receive antennas.

17. A network entity for wireless communication, comprising:
a processing system configured to:
receive frequency domain (FD) correlation information corresponding to a precoded channel, wherein the FD correlation information is indicative of an average FD correlation for each transmission layer of a plurality of transmission layers associated with the precoded channel;
determine a channel estimation matrix for one or more transmission layers of the plurality of transmission layers, wherein the channel estimation matrix corresponds to the precoded channel and is determined based on the average FD correlation for each transmission layer of the one or more transmission layers; and
determine channel estimation information for the precoded channel using the channel estimation matrix.

18. The network entity of claim 17, wherein:
the FD correlation information includes a respective quantized FD correlation value corresponding to the average FD correlation for each transmission layer; and
the processing system is configured to receive information indicative of a quantization configuration associated with the FD correlation information.

19. The network entity of claim 18, wherein the processing system is configured to:
de-quantize the respective quantized FD correlation value for each transmission layer based on the quantization configuration.

20. The network entity of claim 18, wherein the FD correlation information is included in first signaling received from an additional network entity, and wherein the information indicative of the quantization configuration is included in second signaling received from the additional network entity.

21. The network entity of claim 18, wherein the FD correlation information is included in first signaling received from an additional network entity, and wherein the information indicative of the quantization configuration is included in second signaling received from the additional network entity.

22. The network entity of claim 17, wherein the channel estimation matrix is a maximum mean square error (MMSE) channel estimation matrix configured for the plurality of transmission layers and the precoded channel.

23. The network entity of claim 17, wherein, to determine the channel estimation matrix, the processing system is configured to generate one or more updates for the channel estimation matrix corresponding to the precoded channel.
